(19) United States
(12) Patent Application Publication
(10) Pub. No.: US 2003/0179876 A1
(43) Pub. Date: Sep. 25, 2003

(54) Answer resource management system and method

(76) Inventors: Stephen C. Fox, Frisco, TX (US); Michael R. Brown, Plano, TX (US)

Correspondence Address: WILLIAM J. TUCKER, 8650 SOUTHWESTERN BLVD. #2825, DALLAS, TX, 75206, US

(21) Appl. No.: 10/353,843

(22) Filed: Jan. 29, 2003

Related U.S. Application Data
(60) Provisional application No. 60/352,676, filed on Jan. 29, 2002.

(51) Int. Cl. H04M 3/00; H04M 5/00

(52) U.S. Cl. 379/265.02

(57) ABSTRACT

A customer service center (answer resource management system) and method are described herein for answering an inquiry from a customer by combining human interaction and software automation through a transparent interface. Basically, the customer service center is capable of receiving an inquiry (e.g., question, request) from a customer and providing the customer with an answer to the inquiry through a transparent interface on one side of which is the customer and on another side of which is an automated system and an agent. If the automated system is not capable a providing the answer to the customer, then the agent can be consulted in order to provide the answer to the customer. The transparent interface (e.g., text-to-speech interface) is designed such that the agent can provide the answer to the customer without needing to talk directly with the customer.

### CLAIMING BENEFIT OF PRIOR FILED PROVISIONAL APPLICATION

This application claims the benefit of U.S. Provisional Application Serial No. 60/352,676, filed on Jan. 29, 2002 and entitled “Answer Resource Management Architecture” which is incorporated by reference herein.

### BACKGROUND OF THE INVENTION

1. Field of the Invention

This invention relates to the customer care industry and, in particular, to a customer service center and method for answering an inquiry from a customer by combining human interaction and software automation through a transparent interface.

2. Description of Related Art

Customer care if done correctly is regarded as a competitive edge to companies in many different industries. Poor customer care often results in the loss of customers to competitors that can provide better service. The desire of companies to keep their customers means that many companies place a strategic importance on providing quality customer care.

The challenge with providing quality customer care is that traditionally it is very expensive to provide. The most common method of providing customer care is to staff call centers with many customer care agents to handle the inbound requests. This requires one agent per concurrent incoming call, resulting in a large number of call center agents. In addition, it is often necessary to provide customer care beyond normal business hours to support several time zones, necessitating the use of multiple shifts of agents and increasing support costs. Paying the salaries of all these agents becomes very expensive, and the problem only compounds after factoring in training and attrition factors. Industry studies have shown it is not uncommon for call centers to have over 50% attrition a year, forcing tremendous training and scheduling issues and costs.

The high costs associated with providing customer care service can quickly erode a company's profit margin on a customer. As such, there have been many efforts to try to effectively reduce the cost of providing customer care services. Many companies have deployed Interactive Voice Units (IVR) which are automated systems that play pre-recorded messages and have the customer select from multiple menus using their touch-tone (DTMF) phone to receive an answer to their inquiry. These systems can dramatically reduce the cost of servicing a request, but they come at the cost of creating much frustration for the customer and typically result in much lower quality of service ratings from the customers. In addition, these systems usually provide for some sort of escalation procedure to “pound out” which enables frustrated customers to get to a live agent. In practice, the vast majority of customers requests escalation at the very first opportunity resulting in most inquiries going to live agents.

Voice Recognition Units (VRU) attempt to deal with the limitations of IVR's by allowing the user to speak instead of using touch-tone buttons. This approach reduces frustration of users by allowing them to simply speak their request instead of having to wade through multiple pre-recorded menus only to find their specific request was not one of the options. The biggest limitation of VRU deployments, however, is that in order to effectively recognize a speaker-independent spoken request, the exact phrasing spoken has to be anticipated and pre-programmed into the VRU. The number of permutations that can result from an application that has a relatively limited scope can create a large configuration which increases the programming effort needed in order to be effective. In addition, even if the spoken phrase was correctly anticipated, often background noise (mobile phone in a car) or a cough in the middle of the phrase causes the VRU to fail to recognize the request. In practice, most VRU deployments fail to recognize the spoken request around 50% of the time.

A majority of VRU deployments attempt to deal with this problem by escalating the call on a failure to a live agent. This allows the VRU to handle some calls more cost-effectively, and not frustrate the customer too much by escalating to a live agent on a failure condition. The drawback to this approach is that once you have escalated, you are consuming an expensive resource on a one-to-one basis. Even if the VRU could have handled the next several customer requests, once the call has been escalated, the more expensive agent must complete the rest of the call or else the customer can become frustrated by being “bounced around” excessively.

Today some customer service centers associated with U.S. directory assistance operations have attempted to minimize the amount of time required of an agent to finish a call by using a system where once the number requested is identified, the agent can leave the caller to move on to the next caller. An automated system that uses a text-to-speech or pre-recorded numeral concatenation then enunciates the requested number to the caller. There are two main disadvantages to this approach: (1) this approach still requires some one-on-one time between agent and customer which is very expensive; and (2) this approach is only applicable to a narrow segment of the customer care space, in particular ones where the answer to be given to the vast majority of requests falls into a very small answer space, such as phone numbers for the directory assistance case. Most customer care industries have much broader answer spaces to deal with, making this approach not feasible. Accordingly, there is a need for a new customer service center that addresses the aforementioned shortcomings and other shortcomings of traditional customer service centers. These needs and other needs are addressed by the customer service center and method of the present invention.

### BRIEF DESCRIPTION OF THE INVENTION

The present invention includes a customer service center (answer resource management system) and method for answering an inquiry from a customer by combining human interaction and software automation through a transparent interface. Basically, the customer service center is capable of receiving an inquiry (e.g., question, request) from a customer and providing the customer with an answer to the inquiry through a transparent interface on one side of which is the customer and on another side of which is an automated system and an agent. If the automated system is not capable a providing the answer to the customer, then the agent can be consulted in order to provide the answer to the customer. The transparent interface (e.g., text-to-speech interface) is designed such that the agent can provide the answer to the customer without needing to talk directly with the customer.

### BRIEF DESCRIPTION OF THE DRAWINGS

A more complete understanding of the present invention may be had by reference to the following detailed description when taken in conjunction with the accompanying drawings wherein:

FIG. 1 is a block diagram showing the basic components of a customer service center in accordance with the present invention;

FIG. 2 is a block diagram showing the basic components of a preferred embodiment of the customer service center shown in FIG. 1;

FIG. 3 is a flowchart illustrating the steps of a preferred method for operating the customer service center in accordance with the present invention;

FIG. 4 is a flowchart illustrating the in greater detail a first way that method 300 can escalate an inquiry from a customer to an agent; and

FIG. 5 is a flowchart illustrating the in greater detail a second way that method 300 can escalate an inquiry from a customer to an agent.

### DETAILED DESCRIPTION OF THE DRAWINGS

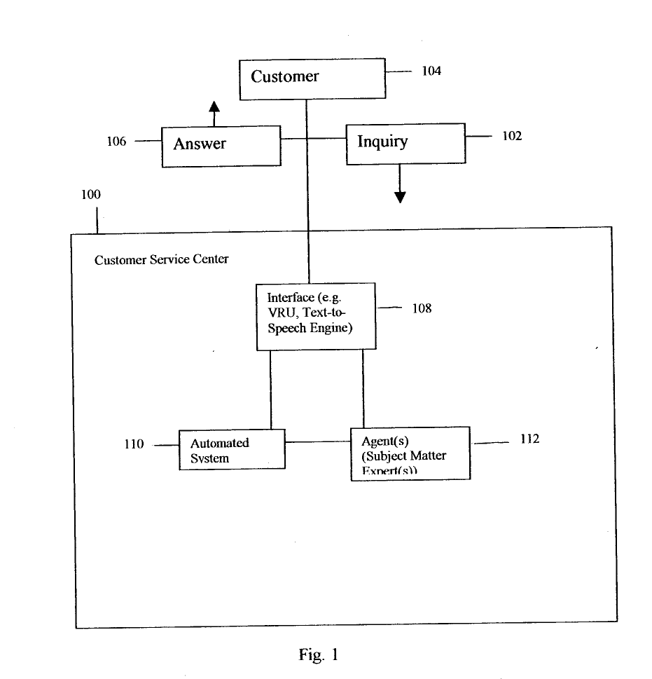

Referring to FIG. 1, there is a block diagram showing the basic components of a customer service center 100 in accordance with the present invention. The customer service center 100 is capable of receiving an inquiry 102 (e.g., question, request) from a customer 104 and providing the customer 104 with an answer 106 to the inquiry 102 through a transparent interface 108 on one side of which is the customer 104 and on another side of which is an automated system 110 and an agent 112. If the automated system 110 is not capable a providing the answer 106 to the customer 104, then the agent 112 is consulted in order to provide the answer 106 to the customer 106. The transparent interface 108 (e.g., text-to-speech interface 108) is designed such that the agent 112 can provide the answer 106 to the customer 104 without needing to talk directly with the customer 104. In this way, the transparent interface 108 effectively makes it so that the customer 104 does not know if the answer 106 was provided by the automated system 110 or by the agent 112. This type of customer service center 100 is a marked improvement over the traditional customer service centers because of several reasons some of which include:

The customer service center 100 provides support to customers 104 at the quality level of the traditional human agent based customer service center while at the same time having the cost-structure of traditional IVRs or other self-help customer service centers.

The customer service center 100 provides a layer of isolation between human agents 112 and customers 104 that greatly reduces the amount of time the human agent 112 must spend on an individual inquiry 102 from the customer 104.

The customer service center 100 provides control of a customer interaction at a finer granularity than is possible with traditional customer service centers 100. For example, one inquiry 102 may need to be escalated to the agent 112 and the next two inquiries 102 may be answered by the automated system 110.

The customer service center 100 from the viewpoint of the customer 104 provides for the transparent escalation to different agents 112. For example, one inquiry 102 may be escalated to one agent 112 and a second inquiry 102 to another agent 112 and the customer 104 would not be able to tell that the answers 106 where provided by two different agents 112.

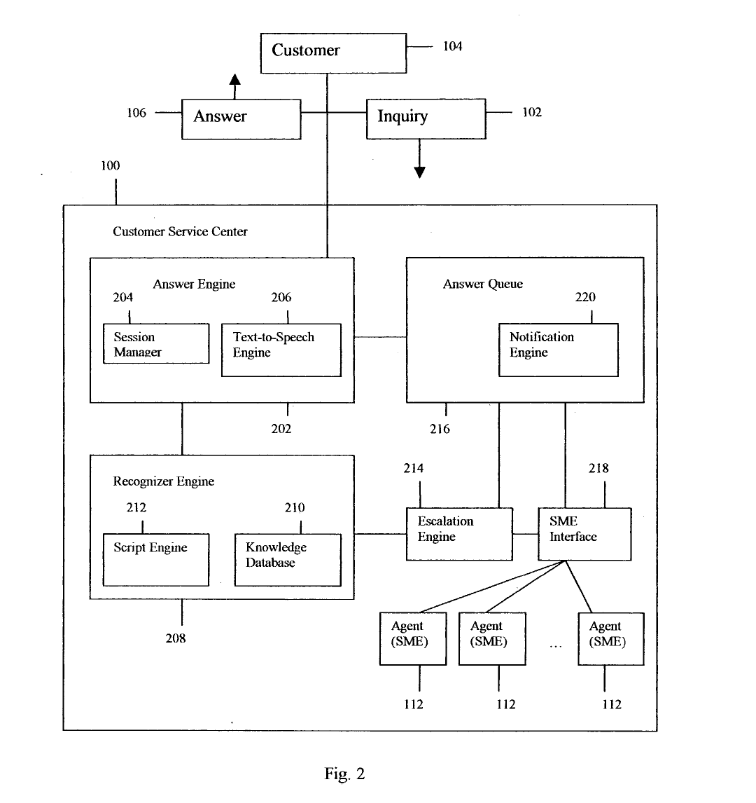

A more detailed description about the architecture and capabilities of the preferred embodiment of the customer service center 100 is provided below with respect to FIGS. 2-5.

Referring to FIGS. 2-5, there are disclosed a block diagram showing the basic components of a preferred embodiment of the customer service center 100 and a flowchart illustrating the steps of the preferred method 300 for operating the customer service center 100. As can be seen in FIG. 2, the customer service center 100 has the following components:

An Answer Engine 202 which is the primary external interface to the customer 104 and is also used to coordinate the resources and other components of the customer service center 100. The primary input to the Answer Engine 202 is the inquiry 102 in either text or speech from the customer 104. The primary output of the Answer Engine 202 is the answer 106 in either text or speech to the customer 104. The Answer Engine 202 is shown to include a Session Manager 204 and a Text-to-Speech Engine 206.

The Session Manager 204 provides for storage and retrieval of attributes related to a particular session of a particular customer 104. The primary input to the Session Manager 204 is a session identifier, the name of the requested session attribute, and an optional value that is stored in the referenced attribute. Examples of values managed by the Session Manager 204 would be a customer identifier, the number of questions asked and answered, the number of failed recognition attempts, and any other values that are unique to an individual customer session.

The Text-to-Speech Engine 206 provides for the conversion of text data into human speech. The primary input to the Text-to-Speech Engine 206 is text data. The primary output from the Text-to-Speech Engine 206 is a generated waveform of the input text that is in a spoken form which is recognizable to the customer 104.

A Recognizer Engine 208 that includes recognition algorithms which are performed against an inquiry 102 received from the Answer Engine 202 in order to find the closest related answer(s) 106, if any. The primary input to the Recognizer Engine 208 is the text or spoken inquiry 102 that was made by the customer 104. The primary output from the Recognizer Engine 208 is a list of the closest inquiry/answer pair(s) it could identify as well as a confidence factor for each pair. The Recognizer Engine 208 as shown includes a Knowledge Database 210 and a Script Engine 212.

The Knowledge Database 210 provides a storage repository and organizes all of the inquiry/answer pairs that the system has been trained on as well as their approval status. The primary input to the Knowledge Database 210 is the inquiry/answer pair. The primary output from the Knowledge Database 210 are the retrieved inquiry/answer pair(s) and their corresponding confidence factor(s). In addition, the Knowledge Database 210 can be designed to search a certain subset of data (e.g., product X data) contained therein depending on the inquiry 102 (e.g., inquiry 102 is related to product X).

The Script Engine 212 provides for scripted interactions where in response to an inquiry 102 several questions need to be asked of the customer 104. The primary input to the Script Engine 212 is a script identifier, step identifier, and the answers to any previous script questions. The primary output from the Script Engine 212 is the next question to ask the customer 104 or the answer in response to the inquiry 102 from the customer 104.

An Escalation Engine 214 that provides for the escalation of the inquiry 102 when the Recognizer Engine 208 does not have an appropriate trained answer for a particular inquiry 102. The primary input to the Escalation Engine 214 is the escalated inquiry 212 and its associated session context (its session identifier and associated history). The primary output from the Escalation Engine 214 is either: (1) the forwarding of the escalated inquiry 212 to the appropriate agent 112 (Subject Matter Expert (SME) 112) whom can interact with an SME Interface 218; or (2) the answer 106 to the escalated inquiry 102 which is sent to an Answer Queue 216.

The SME Interface 218 provides the interface through which one of the agents 112 can provide the answer 106 to the escalated inquiry 102. The primary input to the SME Interface 218 is the escalated inquiry 212 from the Escalation Engine 214. The primary output from the SME Interface 218 is the answer 106 given by the agent 112 in response to the escalated inquiry 102.

The Answer Queue 216 stores the answer 106 from the Escalation Engine 214 or the SME Interface 218 which are to be forwarded to the customer 104. The primary input to the Answer Queue 216 is the answer 106 from the Escalation Engine 214 or the SME Interface 218. The primary output from the Answer Queue 216 is the answer 106 which is to be forwarded to the customer 104. The Answer Engine 202 is used to forward the answer 106 to the customer 104 if the customer 104 is still connected to the customer care center 100. If the customer 104 is no longer connected to the customer care center 100, then a Notification Engine 220 can be used to forward the answer 106 to the customer 104. In addition, the Answer Queue 218 can have a concurrence control algorithm which is used to avoid collisions between multiple customers 104 and agents 112 interfacing the Answer Queue 216 at the same time. The Answer Queue 216 as shown includes the Notification Engine 220.

The Notification Engine 220 provides for the answers 106 to be delivered to the customer 104 through a variety of channels. The primary input to the Notification Engine 220 is the address of the customer 106 to be notified, the answer 106 to be delivered, and the preferred delivery channel (e.g. email, short message (SMS), instant message, WAP, web, phone, etc.) to be used to deliver the answer 106 to that particular customer 104. The primary output from Notification Engine 220 is the answer 106 which is to be delivered to the right location/device chosen by the customer 104.

* The transparent interface 108 described above with respect to FIG. 1 would in this embodiment include the Text-to-Speech Engine 206. And, the automated system 110 described above with respect to FIG. 1 would in this embodiment include components 202, 204, 208, 210, 212, 214, 216, 218 and 220.

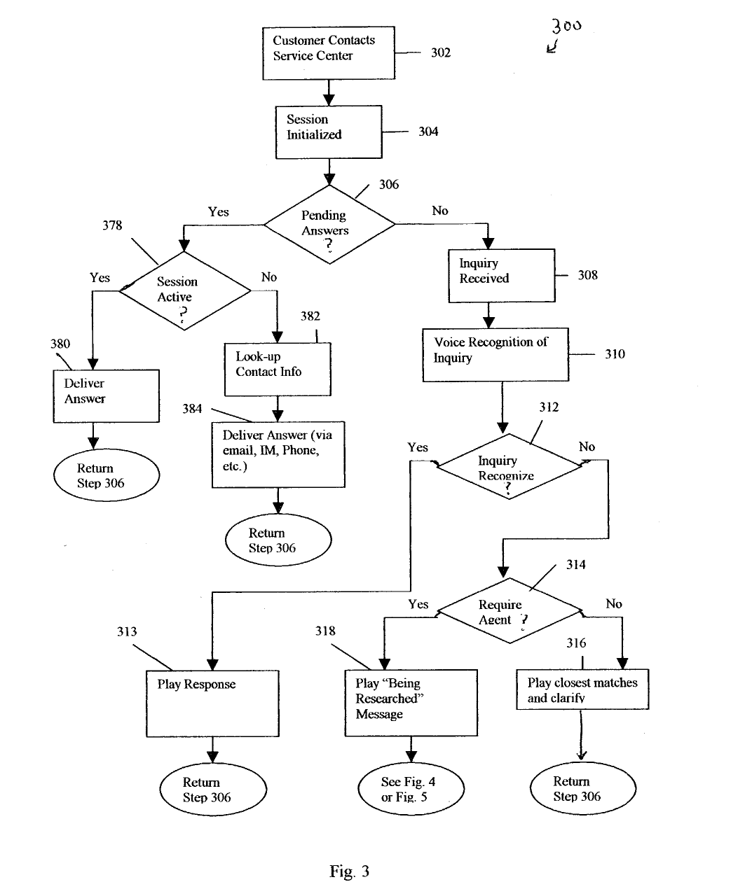

A description as to how each of these components can be used to manage the customer service center 100 and deliver an answer 106 to an inquiry 102 from a customer 104 is described below with respect to FIGS. 3-5.

Referring to FIG. 3, there is a flowchart illustrating the steps of the preferred method 300 for operating the customer service center 100. The customer 104 can use any type of device such as a phone or computer (e.g., Internet web-site) to contact (step 302) the Answer Engine 202. In this example, the customer 104 uses a phone to contact the Answer Engine 202. The Session Manager 204 initializes (step 304) a session by playing the customer 104 an initial greeting and asking the customer 104 if they would like instructions on how to use the customer service center 100. Thereafter, the Answer Queue 216 is checked to determine (step 306) if there are any pending answers 106 associated with this session. Assume at this point in this scenario that there are no pending answers 106 in the Answer Queue 216, the Answer Engine 202 would then wait for the customer 104 to speak (step 308) the inquiry 102. The spoken inquiry 102 is delivered to the Recognizer Engine 208 which processes (step 310) the inquiry 102 using, for example, voice recognition technology. If the inquiry 102 was adequately recognized 120 (step 312), then the Recognizer Engine 208 accesses the Knowledge Database 210 and locates if possible a list of the closest inquiry/answer pairs it could identify as well as a confidence factor for each pair. The Answer Engine 202 would use the Text-to-Speech Engine 206 to play (step 313) the automated answer 106 for the inquiry 102 that had the highest confidence factor assuming the highest confidence factor was above a predetermined threshold. The Answer Engine 202 then checks again if there are any pending answers 106 (step 306) associated with this session. Since no inquiries 102 have been escalated in this scenario yet, there would not be any pending answers 106 in the Answer Queue 216 and the Answer Engine 202 would wait to receive (step 308) the next inquiry 102 if any from the customer 104.

If the voice recognition (step 310) of the second inquiry 102 is not recognized (step 312) or the second inquiry 102 did not have an answer 106 with a high enough confidence factor, then the Recognizer Engine 208 interacts with the Escalation Engine 214 which determines (step 314) if an agent 112 (SME 112) is required. This determination (step 34) could be based on a number of factors, including but not limited to SME availability, customer profile or ranking (e.g., company, revenue, history . . . ) and/or the confidence factor of closest ranking answer 106. If the Escalation Engine 214 determines that an agent 112 is not required, the Answer Engine 202 is instructed to play (step 316) the closest matches returned by Recognizer Engine 208 to the customer 104 for review and selection. If the customer 104 selects one of the options presented, the Answer Engine 202 would play the corresponding answer 106 retrieved from the Knowledge Database 210. Thereafter, the Answer Engine 202 then checks again if there are any pending answers 106 (step 306) associated with this session. Since no inquiries 102 have been escalated to an agent 112 in this scenario yet, there would not be any pending answers 106 in the Answer Queue 216 and the Answer Engine 202 would wait to receive (step 308) the next inquiry 102 if any from the customer 104.

Assuming that the next inquiry 102 passes through steps 306, 308, 310, 312 and then at step 314 the Escalation Engine 214 determines an agent 112 is required, the Answer Engine 202 plays (step 318) a message stating that the inquiry 102 is being researched concurrently and asks if there is anything else it could do to assist the customer 104. Concurrently with this process, the Escalation Engine 214 performs a routing function algorithm to determine which agent 112 (e.g., SME 112) should process the inquiry 102. The routing function algorithm could be based on factors including but not limited to the SME availability, skill-based routing, even-loading among the SMEs, etc.

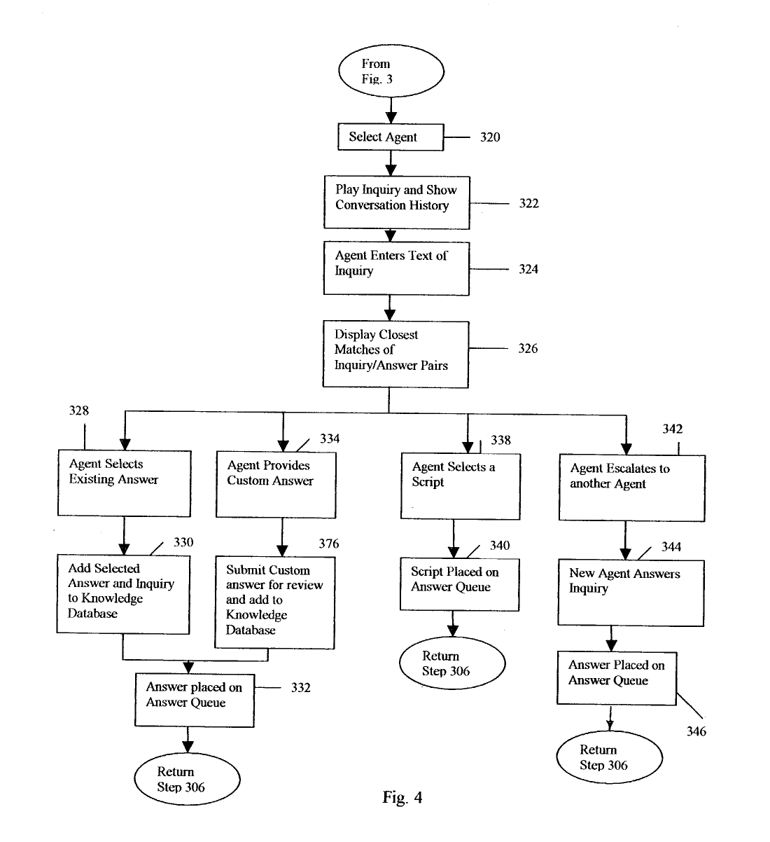

Referring to FIG. 4, there is shown in detail a first way that method 300 can escalate an inquiry 102 to an agent 112. In this embodiment, the Escalation Engine 214 selects (step 320) an agent 112 and then places the escalated inquiry 102 on the queue of that agent 112 in the SME Interface 218. When the agent 112 selects the escalated inquiry 102, the audio of the escalated inquiry 102 and if desired a transcript of the conversation history to aid in establishing context are played/displayed (step 322) for the agent 112. The agent 112 then enters (step 324) the text of the escalated inquiry 102 which the SME Interface 218 uses to display (step 326) a list of closest matches of the inquiry/answer pairs contained in Knowledge Database 210. At this point, the agent 112 has the choice of:

(1) Selecting (step 328) an answer 106 from the list of closest matches of the inquiry/answer pairs received from the Knowledge Database 210. The selected answer 106 and the escalated inquiry 102 could be added (step 330) to an alternative phrasings list in the Knowledge Database 210 after completion of an approval process. The selected answer 106 is placed (step 332) in the Answer Queue 216 and the method 300 then returns to step 306.

(2) Providing (step 334) a custom answer 106 to the customer 104. The custom answer 106 and the escalated inquiry 102 could also be submitted (step 336) for approval or review through the normal workflow processing in order to be added as new content for the Knowledge Database 210. The custom answer 106 is placed (step 332) in the Answer Queue 216 and the method 300 then returns to step 306.

(3) Initiating (step 338) one of several scripts designed to extract further information from the customer 104. To initiate the script to be played for the customer 104, the Script Engine 212 is accessed and a script identifier is placed (step 340) on the Answer Queue 216 which would trigger the Answer Engine 202 to ask a series of questions of the customer 104 to gather more information about the inquiry 102 from the customer 104. The Script Engine 212 and Answer Engine 202 could ask the customer 104 to provide diagnostic or qualification type information. For example, if the agent 112 heard what sounded to be an internet connectivity problem, she could initiate “Run Diagnose Internet Connectivity Script” which would cause the system 100 to run through a set of pre-programmed questions and answers (i.e. “Is the data light on your DSL modem on”, yes, “Do you see a . . . . ”). The method 300 then returns to step 306.

(4) Forwarding (step 342) the escalated inquiry 102 to another agent 112 if they are unable to process the escalated inquiry 102, or if they know of another agent 112 better suited to provide an answer 106 to the escalated inquiry 102. The new agent 112 then provides (step 344) an answer 106 (e.g., custom answer, one of the answers 106 supplied by the Knowledge Database 210) to the customer 104. As described above with respect to steps 330 and 336, this answer 106 and the specifics of the escalated inquiry 102 could be added as content to the Knowledge Database 210 after completion of an approval process. The final answer 106 is placed (step 346) in the Answer Queue 216 and the method 300 then returns to step 306. In this example, the audio of the recorded answer 106 from the second agent 112 could either be played directly for the customer 104 by the Answer Engine 202, or submitted to the Text-to-Speech Engine 206 for transcription to text, allowing the same voice from the Text-to-Speech Engine 206 that was previously heard in this session to be heard again by the customer 104.

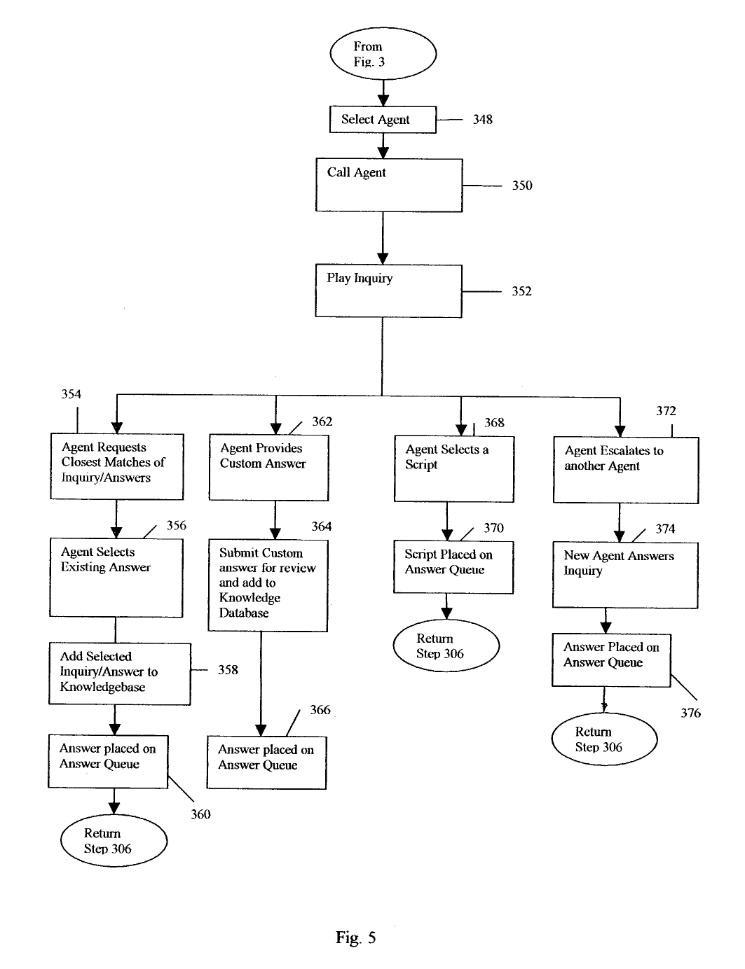

Referring to FIG. 5, there is shown in detail a second way that method 300 can escalate an inquiry 102 to an agent 112. In this embodiment, the Escalation Engine 214 selects (step 348) an agent 112 and then calls (step 350) that agent 112 via a telephony interface. At this point, the Escalation Engine 214 has the audio of the escalated inquiry 102 and if desired a transcript of the conversation history to aid in establishing context are played (step 352) for the agent 112. The agent 112 then can make one of several choices:

(1) Requesting (step 354) a list of the closest matches of the inquiry/answer pairs from the Knowledge Database 210. The agent 112 can then select (step 356) an answer 106 from the list of closest matches of the inquiry/answer pairs received from the Knowledge Database 210. The selected answer 106 and the escalated inquiry 102 could be added (step 358) to an alternative phrasings list in the Knowledge Database 210 after completion of an approval process. The selected answer 106 is placed (step 360) in the Answer Queue 216 and the method 300 then returns to step 306.

(2) Providing (step 362) a custom answer 106 to the customer 104. The custom answer 106 and the escalated inquiry 102 could also be submitted (step 364) for approval or review through the normal workflow processing in order to be added as new content for the Knowledge Database 210. The custom answer 106 is placed (step 366) in the Answer Queue 216 and the method 300 then returns to step 306.

(3) Initiating (step 368) one of several scripts designed to extract further information from the customer 104. To initiate the script to be played for the customer 104, the Script Engine 212 is accessed and a script identifier is placed (step 370) on the Answer Queue 216 which would trigger the Answer Engine 202 to ask a series of questions of the customer 104 to gather more information about the inquiry 102 from the customer 104. The Script Engine 212 and Answer Engine 202 could ask the customer 104 to provide diagnostic or qualification type information. For example, if the agent 112 heard what sounded to be an internet connectivity problem, she could initiate “Run Diagnose Internet Connectivity Script” which would cause the system 100 to run through a set of preprogrammed questions and answers (i.e. “Is the data light on your DSL modem on”, yes, “Do you see a . . . . ”). The method 300 then returns to step 306.

(4) Forwarding (step 372) the escalated inquiry 102 to another agent 112 if they are unable to process the escalated inquiry 102, or if they know of another agent 112 better suited to provide an answer 106 to the escalated inquiry 102. The new agent 112 then provides (step 374) an answer 106 (e.g., custom answer, one of the answers 106 supplied by the Knowledge Database 210) to the customer 104. As described above with respect to steps 330 and 336, this answer 106 and the specifics of the escalated inquiry 102 could be added as content to the Knowledge Database 210 after completion of an approval process. The final answer 106 is placed (step 376) in the Answer Queue 216 and the method 300 then returns to step 306. In this example, the audio of the recorded answer 106 from the second agent 112 could either be played directly for the customer 104 by the Answer Engine 202, or submitted to the Text-to-Speech Engine 206 for transcription to text, allowing the same voice from the Text-to-Speech Engine 206 that was previously heard in this session to be heard again by the customer 104.

It should also be understood the customer 104 can continue making additional inquiries 102 at the same time the escalation process to the agent 112 is taking place as shown in FIGS. 4-5.

Referring back to step 306 in FIG. 3 and assuming an answer 106 to a previously escalated inquiry 102 is pending in the Answer Queue 216, the Answer Engine 202 checks to determine (step 378) if the session is still active with the customer 104. If the session is still active, then the answer 106 from the Answer Queue 216 is delivered (step 380) via the Text-to-Speech Engine 206 to the customer 104 and marked as delivered. If the session is no longer active, then the Answer Engine 202 accesses (step 382) the contact information for the customer 104. Based upon notification preferences of that customer 104, the Notification Engine 220 would deliver (step 384) the answer 106 to the customer 104 using a phone (cell phone), email, personal digital assistant (PDA), computer or some other type of electronic device. If a new call is initiated by the customer 106 before the answer 106 can be forwarded to them, then the Answer Engine 202 treats the new call as a continuation of the previous session and would process step 306 and deliver (step 380) the queued answer 106.

The customer service center 100 and method 300 can also have a web-based embodiment where web-based media can be utilized for communication to and from the customer 104, e.g. a chat type session. In this embodiment the inquiry 102 would be made in text form, and answers 106 delivered in text form, with optional web pages of related content delivered as well. One example of a chat type session that can take place over the Internet between the web-based customer service center (CSC) 100 and the customer 104 is provided below:

Customer 104: Types their question 102 such as “What is Caller ID?”

CSC 100: Outputs “Caller ID shows the name and number calling before you pick up, the phone.”

Customer 104: Types “How much is it?”

CSC 100: Outputs “The monthly price for Caller ID is $8.95. There is also a $6.00 installation fee.”

Customer 104: Types “How do I disable call waiting.”

CSC 100: Outputs “To disable call waiting, lift the phone receiver and press *70. Are you trying to avoid interruptions while you are connected to the Internet?”

Customer 104: Types “Yes.”

CSC 100: Outputs “You may want to consider a DSL Internet Connection. It provides continuous connectivity to the Internet without tying up a phone line or being interrupted by another call. DSL can also provide connections up to 100 times faster than the typical modem. Would you like to know more about how DSL might help you?”

Customer 104: Types “forwarding.”

CSC 100: I did not adequately recognize your question. Here are the closest questions I have been trained on that I could find:

What is forwarding

What is call forwarding

How much is call forwarding

Tell me about call forwarding

Customer 104: Types “How much is call forwarding”. Or, the customer 104 could click on the question to view a web page containing the answer to the clicked question.

CSC 100: Outputs “Call forwarding is $4.00 per month. In this example, the customer service center 100 never needed to escalate an inquiry 102 to an agent 112.

Below are additional examples that highlight some of the capabilities of the customer service center 100 and method 300. In these examples, assume the customer 104 contacts customer service center (CSC) 100 with a question 102 and anyone of the following scenarios can occur:

(1) Question Recognized

(a) Simple inquiry for information:

Customer 104: “Where are you located?”

CSC 100: “We are located in Dallas, Tex. at the . . . ” Corresponding answer from Knowledge Database 210 is delivered back to customer 104 using Text-to-Speech Engine 206.

(b) Order status check

Customer 104: “Has my order shipped.”

CSC 100: “Yes. Your order of 5 units of XYZ shipped on . . . . ”

CSC 100 recognizes the type of request 102 and submits a request to the appropriate back-office system (Billing/MRP/etc) and delivers response 106 to user 104.

(c) User supplied update of information

Customer 104: “Please take me off your mailing list.”

CSC 100: “Your account has been noted. Anything else I can help you with today?”

CSC 100 passes information to back-office system for update.

(2) Question Partially Recognized

CSC 100 delivers closest matches and asks for verification. For example, CSC 100: “I did not fully recognition you question. The closest I could locate for you is: Who is . . . ; Where is . . . Is one of these similar to your question?”

(3) Question Not Recognized

(a) Classification

CSC 100 asks clarifying question to narrow the scope of the search of the Knowledge Database 210 and tries again. For example, CSC 100: “I have multiple responses to your question available in different contexts. Is your question related to our Products, Services, or Corporate Information?”

Customer 104: “Products”

CSC 100: “Ok. In that context, the answer to your question is . . . .”

(b) Escalation

(i) Proxy Escalation (User Side)

(a) Explicit

CSC 100 asks Customer 104 to repeat the question for recording and escalation to a SME 112.

CSC 100: “Could you please repeat your question at the beep so that I may get an answer for you.”

(b) Implicit

CSC 100 automatically records each question, and if not recognized automatically starts the proxy SME escalation procedure.

CSC 100: “I am not trained on your question, but I am having someone research it for you. Anything else I can help you with while we wait for a response?”

(ii) Proxy Escalation (SME Side)

(a) Dedicated SME 112

SME's 112 console receives notification that there is a pending request 102. SME 112 clicks on request 102 and hears recorded request 102 while simultaneously reviewing the conversation log of everything that has been asked/answered so far for this user 104. The SME 112 types the text of the question 102 they hear and the system 100 presents the closest matches from the Knowledge Database 210. The SME 112 can select an appropriate response 106, customize a response 106 for the inquiry 102, or escalate the request 106 to the next level of SME 112. The response 106 from the

SME 112 is then routed by the system 100 and delivered to the user 104 using text to speech.

CSC 100: “I now have an answer to your earlier question of (recording played). The answer is: We have many options . . . . ”

(b) On Call SME 112

Escalation Engine 214 routes request 102 to an on call SME 112. The SME's phone rings and a customized message greets the SME 112, plays the recorded request 102 and asks for direction. The SME 112 can reroute the request 102, select from some preprogrammed responses 106, or record a response 106 to the inquiry. If a recorded response 106 is given, the recording 106 is routed to a transcribers work queue or speech-to-text engine which types the text of the SME's response 106, which allows the CSC 100 to deliver the response 106 seamlessly to the user 104.

(c) SME with Speaker Dependent Voice Recognition.

After training for their voice, the SME 112 can specify a response 106 verbally that the CSC 100 should deliver. The speaker dependent system would translate their spoken words to text, which are then issued to the CSC 100 to forward to the user 104.

(d) Direct Proxy Conversation

Using the combination of speaker-dependent voice recognition and passing the resulting text to the text-to-speech engine an SME 112 could use the CSC 100 as a “puppet” proxy, telling the CSC 100 what to say. This would allow the SME 112 to participate in the process when necessary, and to relinquish control once their participation is no longer necessary, all completely transparent to the user 104. This process could also be used to allow SMEs 112 that have heavy accents to provide service in environments where users 104 might view a heavy accent negatively.

(e) User Call Back

User 104 completes call before the answer 106 to question 102 is delivered. The user's 104 phone number is captured either though direct interrogation or by way of user profile. Upon having the answer to deliver, the CSC 100 dials back the user 104 and delivers the answer 106.

CSC 100: “Hi Jim, I now have an answer to the question you called me about earlier of (question played). The answer is: . . . .

(f) Email Answer Delivery

If the end user 104 disconnects before receiving their answer 106, or prefers the information 106 be sent via email, the answer 106 can be delivered to their specified email address.

CSC 100: “I will send that information to the email address you gave me as soon as I have it.”

(g) SME Directed Programmed Procedures

The SME 112 can direct the CSC 100 to perform pre-programmed time-consuming procedures for commonly encountered scenarios, such as specific diagnostic routines or gathering information to open a trouble ticket.

SME 112: “Open a trouble ticket.”

CSC 100: “Well based on the information you gave me, it appears there is a problem with your equipment. Let me get a little more information from you to schedule a service call. When did you purchase your . . . ?”

(iii) Direct Escalation

(a) User Requested

User 106: “Can I please speak to a live person?”

(b) SME Requested

Anytime an SME 112 is servicing a request 102, they can request to be directly connected with the user 104 initiating the request 102 and be connected directly to discuss more interactively.

(c) CSC Requested.

CSC 100: “I am still having trouble servicing your request. Please hold while I transfer your call to someone that can better assist you.”

(d) User Directed Routing Option

Applicable to both proxy and direct escalation. CSC 100 asks routing questions of user 104 to better direct the request 102.

CSC 100: “Is your question related to Billing, Sales, or Technical Support?”

(4) On the Job Training

An inquiry 102 and final answer 106 that was not provided by the Knowledge Database 210 is recorded for reviewed by a SME 112 or other person for possible inclusion into the Knowledge Database 210. For instance, the question/answer pair can go through a workflow process which can include routing to a different SME 112 and also include obtaining approval from a managing entity before becoming live in the system 100. And, if the system 100 can determine the subject domain of a particular SME 112 then that SME 112 can be selected as the target recipient of the inquiry update. All history related to the inquiry 102: the entire conversation, any other SME 112 responses to it from the escalation process, etc. are kept with the inquiry update through the update process. Once an answer 106 for the question 102 is entered by the SME 112 and approved, the content then becomes available in the Knowledge Database 210.

(5) Notifications to SMEs

(a) Sales

(i) Directed Qualification

A Sales representative 112 registers to have his cell phone called anytime a user 104 has asked “What telecommunication company do you worked with” and “what is your ROI” and the system 100 has determined that the individual 104 works for a company with annual revenues over $500 Mil.

Upon receiving the call the sales representative 112 instructs the system 100 to gather industry specific information about the caller 104.

CSC 100 to SME 112 (sales representative): “Hi Jim, I have a caller that meets your registered criteria.

SME 112: “How many questions have they asked?”

CSC 100: “15”

SME 112: “Execute the project and budget qualification procedure for telecommunications.”

CSC 100: “Ok.”

CSC 100 to User 104: “Do you have a budgeted customer care project you are researching for?”

User 104: “yes”

CSC 100: “What timeframe are you planning for vendor selection”.

(ii) Direct Connection

Same as above but sales representative 112 chooses to talk directly with user 104. CSC 100 connects the two parties together.

SME 112 (sales representative): “Connect me to them.”

CSC 100: “One moment while I connect you.”

SME 112 to User 104: “Hi. I've been told you have an upcoming project that you would like some information from us on how we might be able to help you out. What can I help you with?”

User 104: “Well I mainly was looking for . . .”

(iii) Target Companies

Sales representative 112 registers to be notified anytime the CSC 100 identifies a user 104 from Dell has initiated a conversation.

User 104: “Do you offer corporate discounts?”

CSC 100: “We have some corporate discount agreements in place. What company are you with?”

User 104: “Dell”

System notifies the sales representative 112 via selected email/phone/etc and carries on with user 104. CSC 100: “Yes. We have a 10% discount agreement in place for Dell.”

SME 112 can now ask the CSC 100 about specifics of the conversation and/or ask to be directly connected with the user 104 to “close the deal”

(6) Support

(a) Customer Retention Focus

Studies have shown that there is a high correlation between customers that dropped their service and customers who had more than two support calls related to service outage. As a result, CSC 100 can be configured to automatically escalate with a high priority any support call 102 that CSC 100 identifies as a service outage call and has a history of two other service calls within 60 days immediately to live SME 112. Calls 102 from customers 104 without this type of history are given the normal known service outage type message 106. In this way, customer support resources are focused on where they can best impact the success of the business associated with the CSC 100.

User 104: “My internet connection is down.”

CSC 100: “Ok. Can I have your account number please?”

User 104: “9724445555”

CSC 100 identifies past history and decides to escalate the user 104 to a SME 112.

CSC 100: “Thank you. I am routing you directly to one of our senior technicians to resolve your issue.”

SME 112 (service technician): “Is the Data light on your modem lit?”

(b) Premier Customer Focus

Similar to the aforementioned customer retention focus scenario, routing and level of support decisions can be made based upon the segmentation of the customer base. For example, standard customers 104 are escalated to a SME 112 after several attempts by CSC 100 to service and/or categorize the inquiry 102. “Gold” customers 104 would escalate earlier but stay in proxy mode speaking via text mode with the SME 112. “Platinum” customers 104 are immediately routed to a live SME 112 upon first indication of any trouble servicing the call 102.

Example: Airline Reservations:

User 104: “What is the last flight to LA tonight?”

CSC 100: “We have a 9:45 pm departure arriving at 11:20 pm.”

User 104: “Are there first class upgrades available on that flight?”

CSC 100: “I'll check for you. Can I have your Advantage number?”

User 104: “U44455”

CSC 100 interrogates back office and determines the user 104 has Platinum status, upgrade availability, etc.

CSC 100: “Yes. There are upgrade available for our Platinum members.”

User 104: “Is it possible to make that a round trip flight that routes through Denver on the way back?”

CSC 100: Has trouble identifying the request 102. Normally would ask a clarifying or category type question, instead chooses to escalate the user 104 to the SME 112.

CSC 100: “I'm sorry, I did not fully understand your request. Please hold while I connect you with someone to assist you.”

SME 112 (after reviewing conversation log.): “Yes. We can route you through Denver on the return. When were you wanting to return and how long of a layover do you desire?”

(c) Feedback

At any time, the user 104 can provide feedback to the CSC 100 on how it is servicing their requests 102. This information is recorded and available for review through the reporting system via the Session Manager 204.

User 104: “Who are your customers?”

CSC 100: “We have customers in the financial and energy industries.”

User 104: “No, that's not what I meant.”

CSC 100 records negative feedback for last question/answer pair.

(d) Reporting

The entire conversation log of each conversation is available for review via reports. In addition, aggregate reports are available to show trends and volumes, etc. These reports can be made available via web or phone channels.

Executive of CSC 100: “How many calls did we have from our Premier customers last month?”

CSC 100: “587”

Executive: “What percentage of those were resolved within 24 hours?”

CSC 100: “64%”

Executive: “How many people asked about our special offers?”

CSC 100: “423 or about 22% of the total number of calls.”

Executive: “Of those, how many placed an order?”

CSC 100: “85%”

(7) Web-based CSC 100

A web-based CSC 100 mimics the phone-based CSC 100 for the most part. The main differences are instead of a direct connection, a chat session would be started, and the web-based CSC 100 has the ability to pull up related web content for the user 104 that is not practical for the phone-based CSC 100. It is also more palatable for the web-based CSC 100 to suggest similar questions upon not recognizing a question 102 since most people 104 can read faster than someone can speak. The web-based CSC 100 is well suited to replace and enhance the traditional search mechanism on most web sites, while providing a continuity of interface and feedback through the reporting system.

(8) InstantMessage (IM) based CSC 100

The IM based CSC 100 is analogous to the web-based CSC 100 but the medium is the IM environment. The scenarios mimic the web and phone scenarios with the additional advantage that even when a live SME 112 gets involved the end user 104 does not have to know that an escalation has even occurred. It would appear as one seamless conversation.

Following are some of the advantages associated with the customer service center 100 and method 300:

The customer service center 100 and method 300 can be implemented at a substantially lower cost than traditional customer service centers by blending automation technologies with live agents in a way that lowers the aggregate cost of providing customer service without forfeiting the quality of support that traditionally requires large amounts of expensive human resources.

The customer service center 100 and method 300 provides a more cost-effective way of managing the resources required to answer customer inquiries 102. The invention blends software automation with live agents to answer each inquiry 102 using the most cost-effective resource while maintaining a seamless and single-point-of-contact interface to the customer 104.

The customer service center 100 and method 300 provides quality customer care at a fraction of the cost of traditional customer service centers by blending software automation technologies such as IVR and voice recognition technologies with live agents 112. Automation technologies are used to their full extent, but then augmented in the inevitable failure cases to be covered by live agents 112, but in a transparent manner that keeps the customer 104 engaged in the automation interface instead of escalating to an expensive one-on-one conversation with an agent 112. This allows agents 112 to be more effective and gives the automation technology more opportunities to successfully resolve the customer's requests 102 at a lower cost point. In addition, the customer service center 100 provides for processes to learn from usage over time, making the overall efficiency and effectiveness grow over time.

The customer service center 100 and method 300 provides a process through which the customer service center 100 can learn through usage to be able to automatically answer requests 102 that were previously escalated to a live agent 112.

The customer service center 100 and method 300 provides for a more efficient way to transcript calls for reporting purposes.

Although only a couple embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims. For example, a human agent 112 could be dedicated to process the escalation requests to decide if and to whom a request should be escalated. Also, the SME Interface 218 could be augmented to allow for speaker-dependent voice recognition to enable a completely voice based interface that would still maintain the advantages of a degree of separation between customer 104 and agent 112.

What is claimed is:

1. A customer service center capable of receiving an inquiry from a customer and providing the customer with an answer to the inquiry through a transparent interface on one side of which is the customer and on another side of which is an automated system and an agent, wherein if the automated system is not capable of providing the answer to the customer then the agent can be consulted in order to provide the answer to the customer.

2. The customer service center of claim 1, wherein said transparent interface is a text-to-speech engine designed such that the agent can provide the answer to the customer without needing to talk directly with the customer.

3. The customer service center of claim 1, wherein said transparent interface is a text-to-speech engine designed such that the customer does not know if the answer was provided by the automated system or the agent.

4. The customer service center of claim 1, wherein said automated system includes an answer engine and session manager capable of supporting and coordinating various components of the customer service center.

5. The customer service center of claim 1, wherein said automated system includes a recognizer engine that has a knowledge database capable of storing a plurality of answers to a plurality of inquiries at which the inquiry from the customer is compared to the plurality of inquiries in an attempt to find the corresponding answer.

6. The customer service center of claim 5, wherein said recognizer engine and said knowledge database assigns a confidence factor to the corresponding answer.

7. The customer service center of claim 1, wherein said automated system includes an escalation engine capable of determining whether or not to escalate the inquiry to the agent.

8. The customer service center of claim 7, wherein said escalation engine determines whether or not to escalate the inquiry to the agent based on a status of the customer.

9. The customer service center of claim 7, wherein said agent can provide the answer to the escalated inquiry by:
selecting, from a knowledge database, an answer to the escalated inquiry;
providing a custom answer to the escalated inquiry;
selecting, from an answer script engine, a script to be played to the customer so as to obtain more information about the escalated inquiry and then providing an answer to the escalated inquiry; or
contacting another agent to have that agent provide an answer to the escalated inquiry.

10. The customer service center of claim 7, wherein said automated system is capable of learning by automatically providing an answer to a future inquiry that was previously escalated to and answered by the agent.

11. The customer service center of claim 7, wherein said escalation engine interacts with an answer queue capable of storing the answer to the escalated inquiry and said answer queue has a notification engine capable of forwarding the stored answer to a predetermined electronic device used by the customer if the customer is no longer connected to the customer service center.

12. The customer service center of claim 7, wherein said customer can make another inquiry while the escalated inquiry is being processed by the escalation engine or the agent.

13. The customer service center of claim 1, wherein said automated system is capable of generating at least one status report.

14. The customer service center of claim 1, wherein said automated system includes an escalation engine capable of forwarding the inquiry to the agent who is also a sales representative depending on a nature of the inquiry.

15. The customer service center of claim 1, wherein said inquiry is a question or a request.

16. The customer service center of claim 1, wherein said customer service center is an answer resource management system.

17. The customer service center of claim 1, wherein said customer service center is a phone-based customer service center.

18. The customer service center of claim 1, wherein said customer service center is a web-based customer service center.

19. The customer service center of claim 1, wherein said customer service center is an instant message based customer service center.

20. A method for operating a customer service center, said method comprising the steps of:
receiving an inquiry from a customer; and
providing the customer with an answer to the inquiry using a transparent interface on one side of which is the customer and on another side of which is an automated system and an agent, wherein if the automated system is not capable of providing the answer to the customer then the agent can be consulted in order to provide the answer to the customer.

21. The method of claim 20, wherein said transparent interface is a text-to-speech engine designed such that the agent can provide the answer to the customer without needing to talk directly with the customer.

22. The method of claim 20, wherein said transparent interface is a text-to-speech engine designed such that the customer does not know if the answer was provided by the automated system or the agent.

23. The method of claim 20, wherein said automated system includes an answer engine and session manager capable of supporting and coordinating various components of the customer service center.

24. The method of claim 20, wherein said automated system includes a recognizer engine that has a knowledge database capable of storing a plurality of answers to a plurality of inquiries at which the inquiry from the customer is compared to the plurality of inquiries in an attempt to find the corresponding answer.

25. The method of claim 24, wherein said recognizer engine and said knowledge database assigns a confidence factor to the corresponding answer.

26. The method of claim 20, wherein said automated system includes an escalation engine capable of determining whether or not to escalate the inquiry to the agent.

27. The method of claim 26, wherein said escalation engine determines whether or not to escalate the inquiry to the agent based on a status of the customer.

28. The method of claim 26, wherein said agent can provide the answer to the escalated inquiry by:
selecting, from a knowledge database, an answer to the escalated inquiry;
providing a custom answer to the escalated inquiry;
selecting, from an answer script engine, a script to be played to the customer so as to obtain more information about the escalated inquiry and then providing an answer to the escalated inquiry; or
contacting another agent to have that agent provide an answer to the escalated inquiry.

29. The method of claim 26, wherein said automated system is capable of learning by automatically providing an answer to a future inquiry that was previously escalated to and answered by the agent.

30. The method of claim 26, wherein said escalation engine interacts with an answer queue capable of storing the answer to the escalated inquiry and said answer queue has a notification engine capable of forwarding the stored answer to a predetermined electronic device used by the customer if the customer is no longer connected to the customer service center.

31. The method of claim 26, wherein said customer can make another inquiry while the escalated inquiry is being processed by the escalation engine or the agent.

32. The method of claim 20, wherein said automated system is capable of generating at least one status report.

33. The method of claim 20, wherein said automated system includes an escalation engine capable of forwarding the inquiry to the agent who is also a sales representative depending on a nature of the inquiry.

34. The method of claim 20, wherein said inquiry is a question or a request.

35. The method of claim 20, wherein said customer service center is an answer resource management system.

36. The method of claim 20, wherein said customer service center is a phone-based customer service center.

37. The method of claim 20, wherein said customer service center is a web-based customer service center.

38. The method of claim 20, wherein said customer service center is an instant message based customer service center.
